(19) United States
(12) Patent Application Publication
(10) Pub. No.: US 2005/0049890 A1
(43) Pub. Date: Mar. 3, 2005

(54) Method and system for processing returned postal mail using barcode application technology

(76) Inventor: Jong-Heum Kan, Seoul (KR)

Correspondence Address: CANTOR COLBURN LLP, 55 Griffin Road South, Bloomfield, CT, 06002, US

(21) Appl. No.: 10/717,893

(22) Filed: Nov. 20, 2003

(30) Foreign Application Priority Data
Aug. 26, 2003 (KR) 10-2003-0059251

(51) Int. Cl. G06F 17/60

(52) U.S. Cl. 705/1

(57) ABSTRACT

A system and method for processing returned postal mail using barcode application technology is provided. The method includes receiving forwarded mail information from a sender and making the forwarded mail information into a database; extracting a recipient's address and corresponding mail information from the forwarded mail information, printing a zip code number barcode and an information collection barcode on predetermined positions, respectively, on an envelope, and reporting mail shipment to the sender; receiving returned mailpieces, sorting the returned mailpieces by reason for return, and recording a reason for return of each returned mailpiece; reading the information collection barcode printed on each returned mailpiece and making returned mail information into a database; and reporting a result of processing the returned mailpieces to the sender through the communication network, extracting a recipient information from the returned mail information, and reporting to a corresponding recipient through the communication network that a mailpiece having been forwarded to the recipient is returned.

### BACKGROUND OF THE INVENTION

1. Field of the Invention

The present invention relates to a method and system for processing returned postal mail using barcode application technology, and more particularly, to a method and system for processing returned postal mail using barcode application technology, through which a barcode containing sender information (for example, a credit card company, an insurance company, a mobile communication company, a telephone office, a national health insurance corporation, or a national pension corporation), agent information (for example, Telsonebill corporation, Camp corporation, Hanyoung System corporation, Hanacom corporation, or Dongkook DM corporation), and particular information (for example, a sender classification, a sender company name, an agent company name, a customer ID, a customer's e-mail address, or a customer's mobile phone number) is attached to a mailpiece; and an agent company (for example, an authorized post office or e-posting) handling returned mailpieces collects returned mailpieces, scans an information collection barcode on a returned mailpiece at a high speed, reports a reason for return of the mailpiece and mail information regarding the mailpiece to the sender, and reports the fact that the mailpiece is returned to a recipient of the returned mailpiece through a particular means (for example, an Internet e-mail service or a short message service (SMS)) so that information regarding the recipient can be corrected.

2. Description of the Related Art

Generally, various service companies or public institutions such as credit card companies, insurance companies, wired/wireless communication companies, telephone offices, national health insurance corporations, and national pension corporations, manage customers' addresses and telephone numbers and send bills or notifications on credit card settlement, telephone rate, power rate, national pension, etc. by mail. To increase business efficiency, these service companies or public institutions designate a particular agent company (for example, Telsonebill, Camp, Hanyoung System, Hanacom, or Dongkook DM) to send out a bunch of mail on behalf of the service companies or the public institutions.

According to a customer barcoding system introduced to Korea in December 1998 to swiftly sort mail by destination zone to which mail is delivered, a mail center receive a bunch of mailpieces on which a barcode corresponding to a recipient's zip code number is printed at a specified position in specified size. According to the customer barcoding system, when a sender (for example, a mail agent company) posts a large number of mailpieces (for example, postpaid 1000 or more mailpieces per time or separately paid 2000 or more mailpieces per time), the sender can have the benefit of discount on postal charges at a specified rate (for example, 3%) in addition to an existing discount rate. A barcode used in the customer barcoding system is a 3 out of 5 barcode, i.e., a linear barcode developed to fast process mailpieces. This barcode is composed of a recipient's zip code number (having 6 digits) and a parity check (having 1 digit) for checking a barcode error. When the customer barcoding system is used, thirty thousand or more mailpieces can be sorted by zone per hour, and cost for additional equipment and mail processing incurred due to an increase in the amount of mail can be reduced.

According to the statistics issued by Ministry of Information and Communication in the Republic of Korea in 2000, the number of domestic mailpieces was more than 3.5 billion, and the number of returned mailpieces was more than 7 hundred million. In Korea, more than 20% of the people move, travel on business, and change workplaces. Accordingly, customers' addresses are frequently changed, and customers need to report their changed addresses to companies having an account with the customers. However, a report rate is very low because reporters feel inconvenience or annoyance. For this reason, bills or insurance termination notifications are delivered wrongly, and thus returned mail is increasing. An increase in returned mail results in waste of social and financial cost. Meanwhile, the customers suffer from a financial disadvantage in that they are listed as having poor credit or burdened with overdue interest since they cannot keep the time limit of payment.

In the meantime, returned mail is manually sorted and sent back to a mail agent company or a sender. Here, the mail agent or the sender checks mailpieces one by one to identify a recipient of the returned mail. However, a lot of returned mail is neglected and deserted. Moreover, it takes lots of time and efforts to handle returned mail.

### SUMMARY OF THE INVENTION

The present invention provides a method and system for processing returned postal mail using barcode application technology, in which a standardized barcode (including a one-dimensional barcode and a two-dimensional barcode) containing particular information (for example, a sender classification, a sender company name, an agent company name, a customer ID, a customer's e-mail address, or a customer's mobile phone number) is printed on a specified position on a mailpiece when the mailpiece is posted, and an information collection barcode on a mailpiece is fast scanned to read the information collection barcode when the mailpiece is returned, so that return of the mailpiece can be swiftly and accurately performed through a scientific procedure.

The present invention also provides a method and system for processing returned postal mail using barcode application technology, in which mail information regarding a mailpiece and a reason for return of the mailpiece are made into a database based on information obtained by reading an information collection barcode on the returned mailpiece, returned mail information including the mail information and the reason for return is reported to all senders in real time, and simultaneously the fact that the mailpiece is returned is reported to a recipient of the returned mailpiece through a particular means (for example, an Internet e-mail service or a short message service (SMS)), so that information regarding the recipient can be corrected.

According to an aspect of the present invention, there is provided a system for processing returned postal mail using barcode application technology, the system receiving addresses of respective recipients, to whom a large number of mailpieces are to be forwarded in response to a sender's request, and mail information; printing a zip code number barcode and an information collection barcode on predetermined positions, respectively, on an envelope using a barcode printer included in a mail agent company; requesting a mail center to deliver a large number of mailpieces; making returned mail information regarding each returned mailpiece received from the mail center into a database; reports the returned mail information to the sender through a communication network; and reporting a recipient that a mailpiece having been forwarded to the recipient is returned through the communication network. The system includes a barcode reader which reads a particular barcode on each returned mailpiece received from the mail center; a data input unit which generates and outputs a key signal ordering a particular operation to be executed or receives and transmits particular data; a mail processing server connected to the communication network, the barcode printer, the barcode reader, and the data input unit, the mail processing server transmitting data to and receiving data from the communication network, arithmetically processing the mail information obtained by the barcode reader and various types of data received from the data input unit, manages the mail information and the data to be made into a database, and controlling elements of the system to perform predetermined operations; a forwarded mail information database connected to the mail processing server, the forwarded mail information database making forwarded mail information received from the mail processing server into a database, and extracting and outputting data in response to a request from the mail processing server; and a returned mail information database connected to the mail processing server, the returned mail information database making returned mail information received from the mail processing server into a database, and extracting and outputting data in response to a request from the mail processing server.

According to another aspect of the present invention, there is provided a method of processing returned postal mail using barcode application technology. In the method, addresses of respective recipients, to whom a large number of mailpieces are to be forwarded in response to a sender's request, and mail information are received; a zip code number barcode and an information collection barcode are printed on predetermined positions, respectively, on an envelope using a barcode printer included in a mail agent company; a mail center is requested to deliver a large number of mailpieces; returned mail information regarding each returned mailpiece received from the mail center is made into a database; the returned mail information is reported to the sender through a communication network; and a recipient is reported through the communication network that a mailpiece having been forwarded to the recipient is returned. The method includes receiving forwarded mail information from the sender and making the forwarded mail information into a database; extracting a recipient's address and corresponding mail information from the forwarded mail information, printing a zip code number barcode and an information collection barcode on predetermined positions, respectively, on an envelope, and reporting mail shipment to the sender; receiving returned mailpieces, sorting the returned mailpieces by reason for return, and recording a reason for return of each returned mailpiece; reading the information collection barcode printed on each returned mailpiece and making returned mail information into a database; and reporting a result of processing the returned mailpieces to the sender through the communication network, extracting a recipient information from the returned mail information, and reporting to a corresponding recipient through the communication network that a mailpiece having been forwarded to the recipient is returned.

### BRIEF DESCRIPTION OF THE DRAWINGS

The above object and advantages of the present invention will become more apparent by describing in detail preferred embodiments thereof with reference to the attached drawings in which:

FIG. 1 illustrates an entire service procedure of a system for processing returned postal mail according to the present invention;

FIG. 2 is a diagram showing a procedure in which a returned mail agent company processes returned mail according to the present invention;

FIG. 2A is a diagram showing a barcoded envelope, which includes a one-dimensional barcode, according to an embodiment the present invention;

FIG. 2B is a diagram showing a barcoded envelope, which includes a two-dimensional barcode, according to another embodiment of the present invention;

FIG. 2C is a diagram showing a structure of an information collection barcode according to the present invention;

FIG. 2D is a diagram showing a structure of a database related to information collection barcodes according to the present invention;

FIG. 2E is a diagram showing a procedure of scanning a barcode according to the present invention;

FIG. 2F is a diagram showing a procedure of reporting a reason for return according to the present invention;

FIG. 2G is a diagram showing a structure of a database including returned mail information according to a reason for return according to the present invention;

FIG. 2H is a diagram showing an example of statistical information contained in a report informing a particular sender of returned mail information according to the present invention;

FIG. 2I is a diagram showing an example of particulars of the report informing a particular sender of returned mail information according to the present invention;

FIG. 2J illustrates a service procedure of guiding customers to change their addresses according to the present invention;

FIG. 3 is a diagram showing a structure to which a system for processing returned postal mail according to an embodiment of the present invention is applied; and

FIG. 4 is a flowchart of a method of processing returned postal mail according to an embodiment of the present invention.

### DETAILED DESCRIPTION OF THE INVENTION

Hereinafter, preferred embodiments of the present invention will be described in detail with reference to the attached drawings.

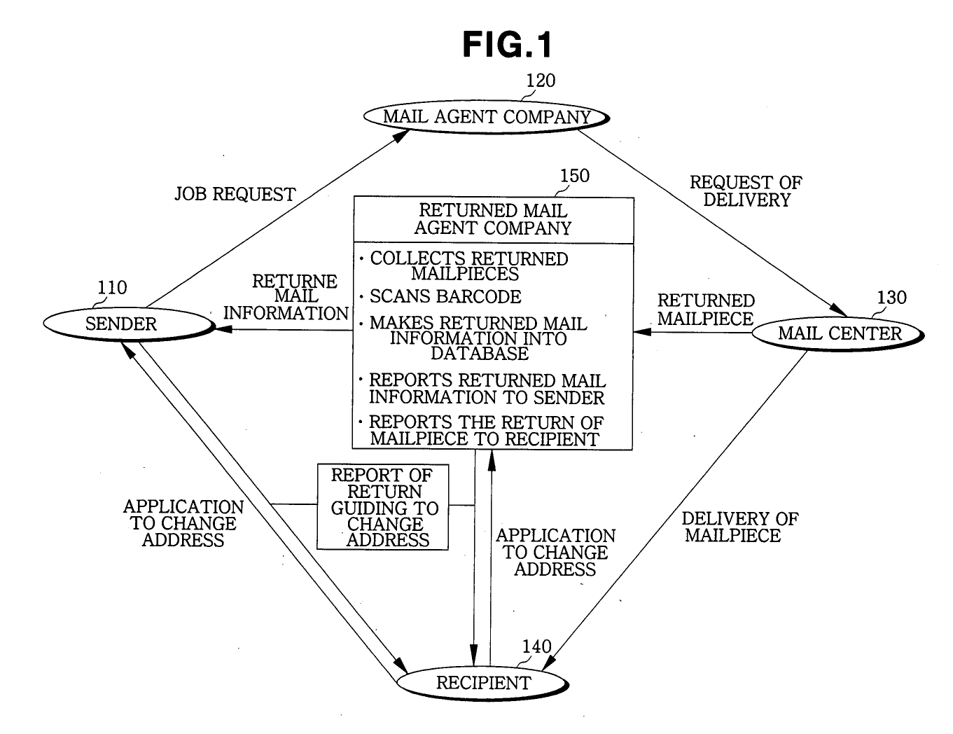

FIG. 1 illustrates an entire service procedure of a system for processing returned postal mail according to the present invention. A sender 110 is a subject sending a large amount of mail and may be a credit card company, an insurance company, a wired/wireless communication company, a telephone office, a national health insurance corporation, or a national pension corporation. The sender 110 transmits information (for example, customer's address, ID, and e-mail address) on a customer whom the sender 110 is to mail and content of mail (for example, a bill or a notification) to a mail agent company 120 on-line or off-line to request the mail agent company 120 to send mail on behalf of the sender 110.

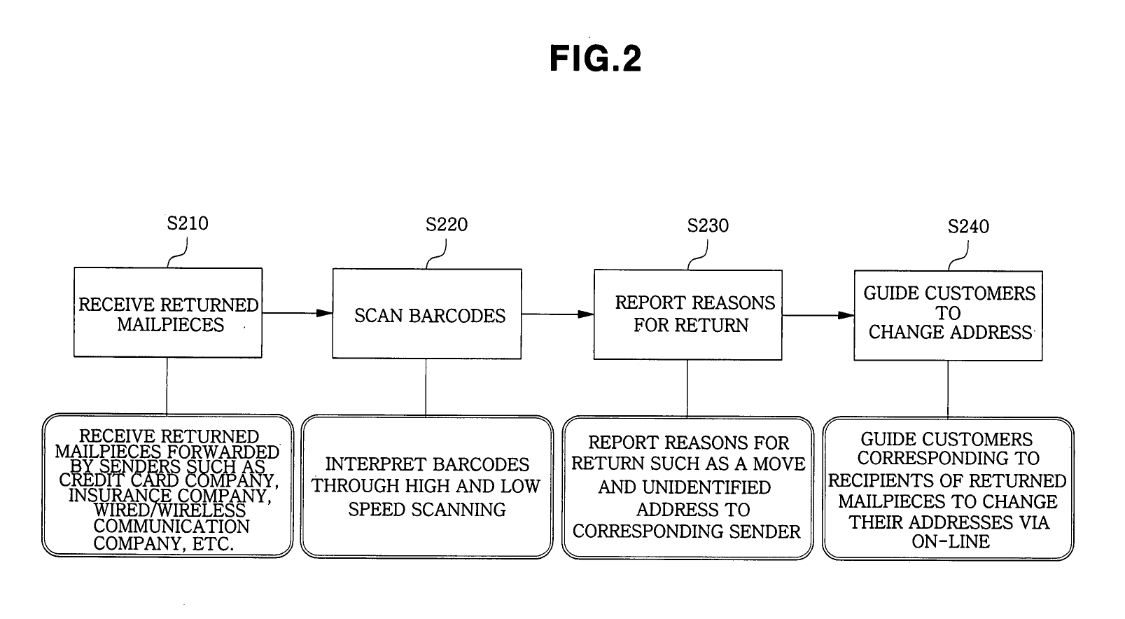

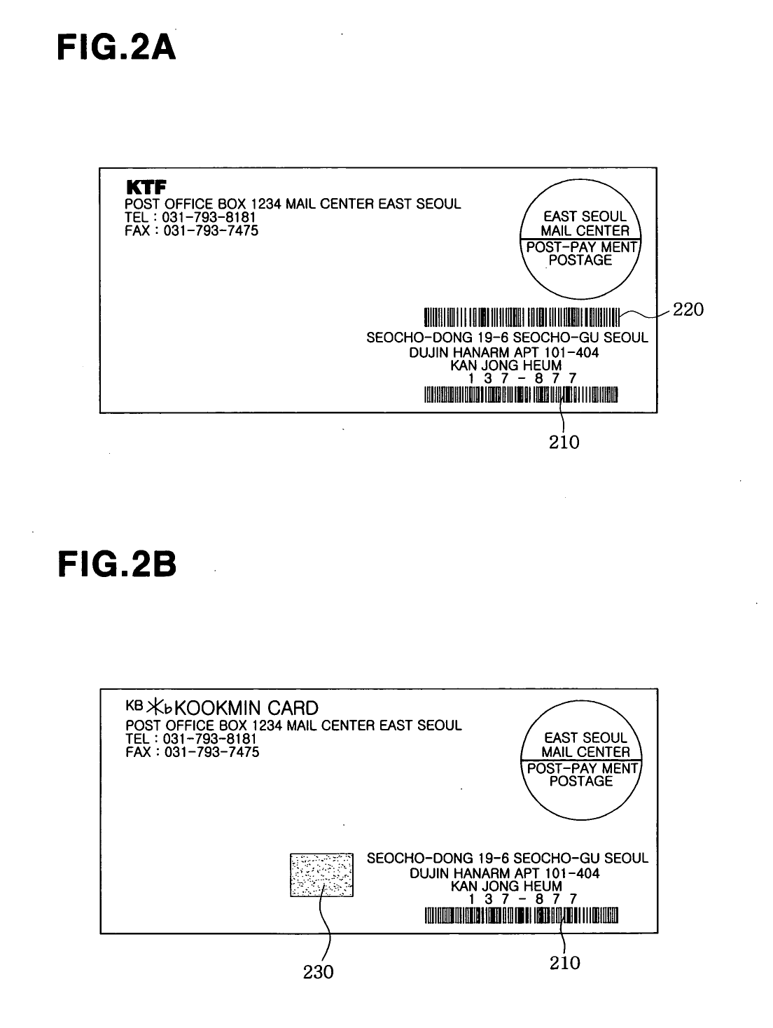

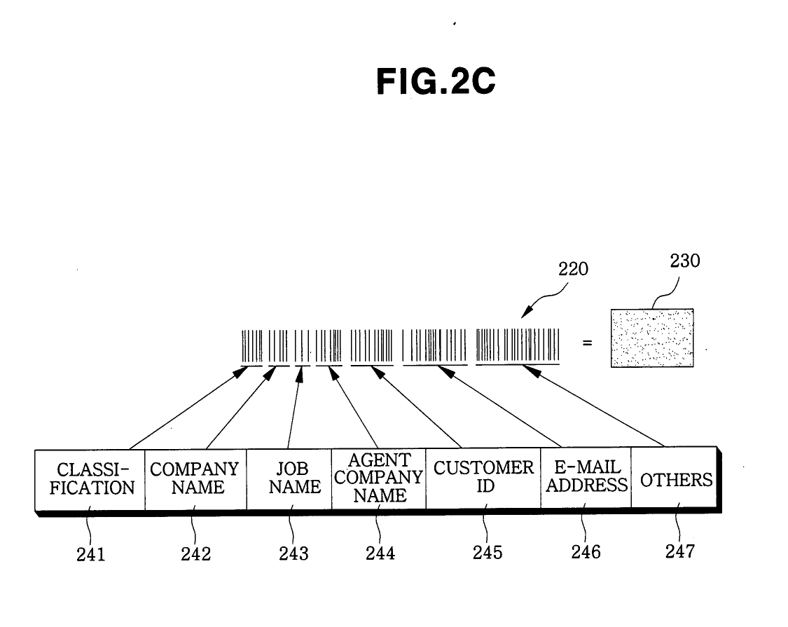

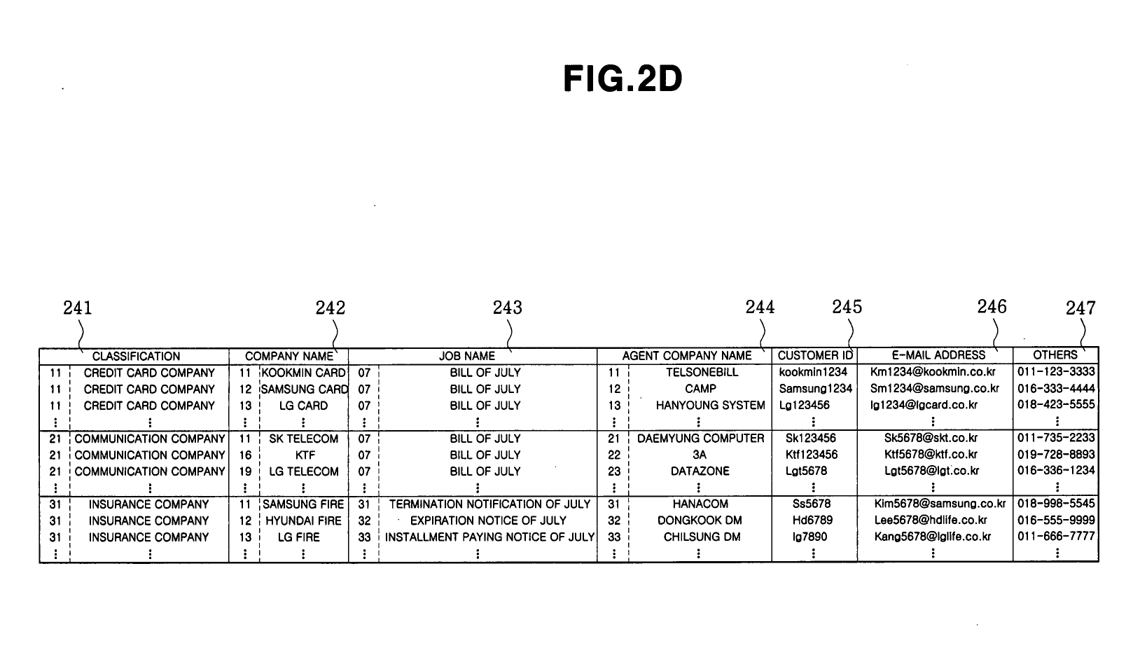

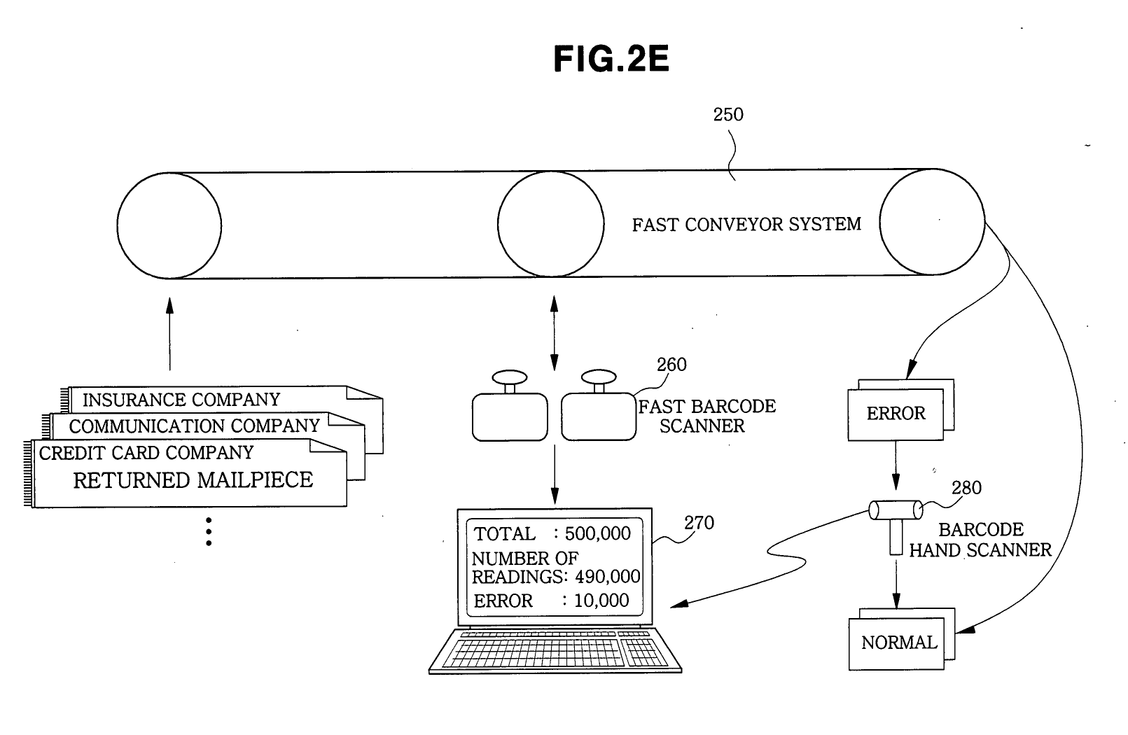

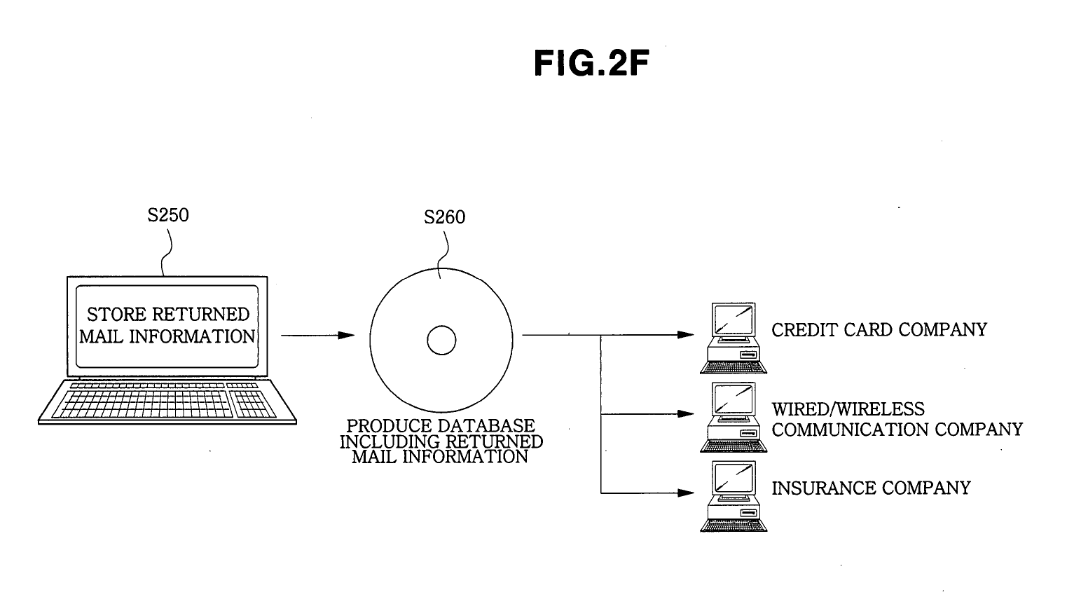

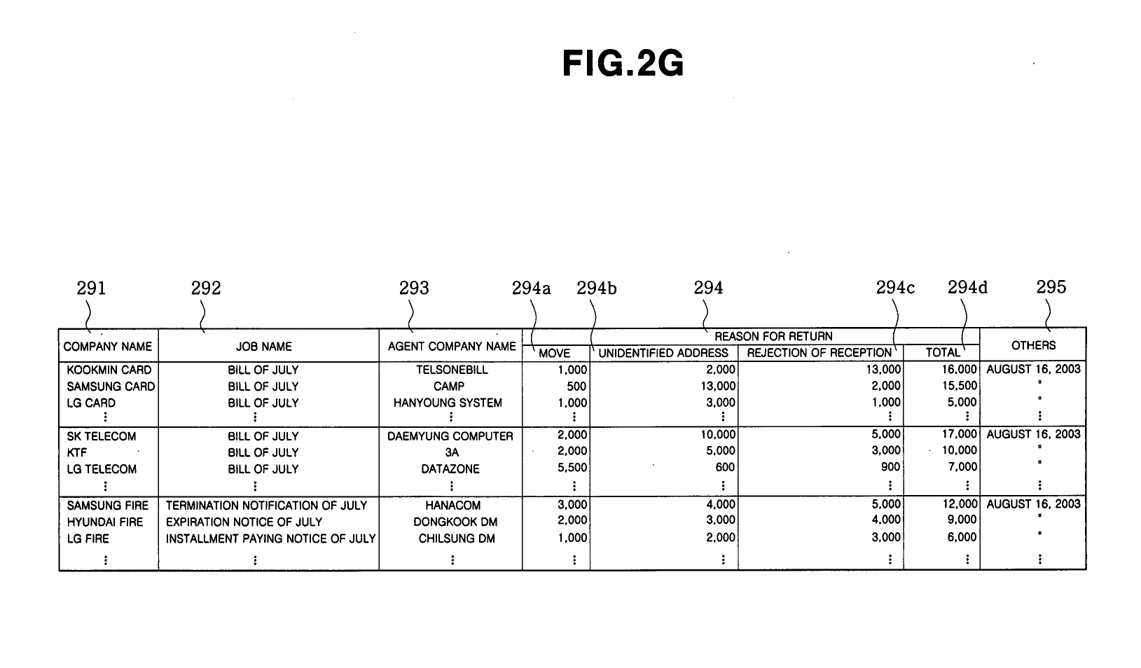

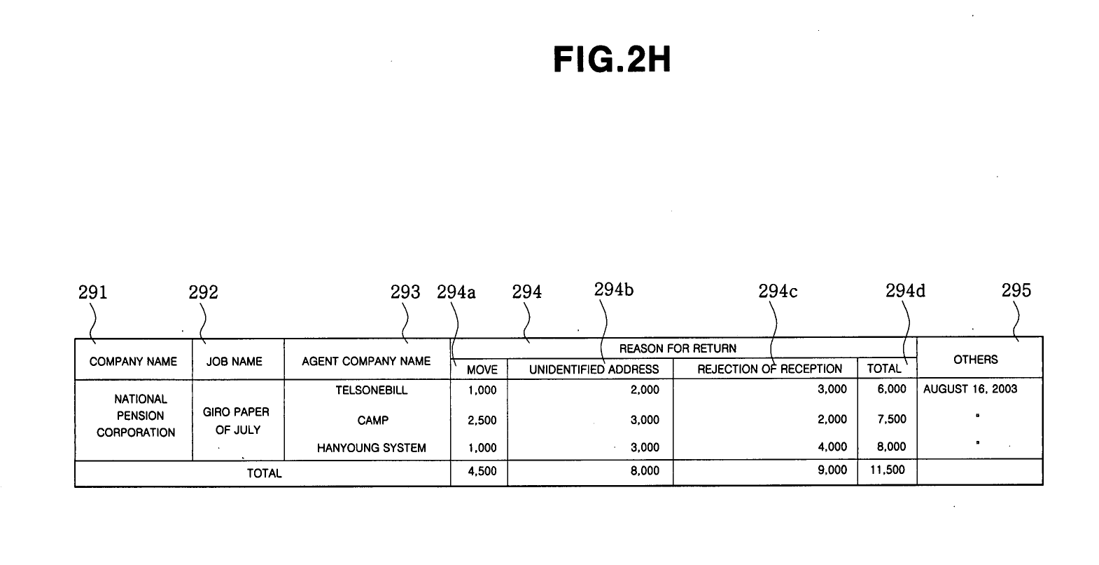

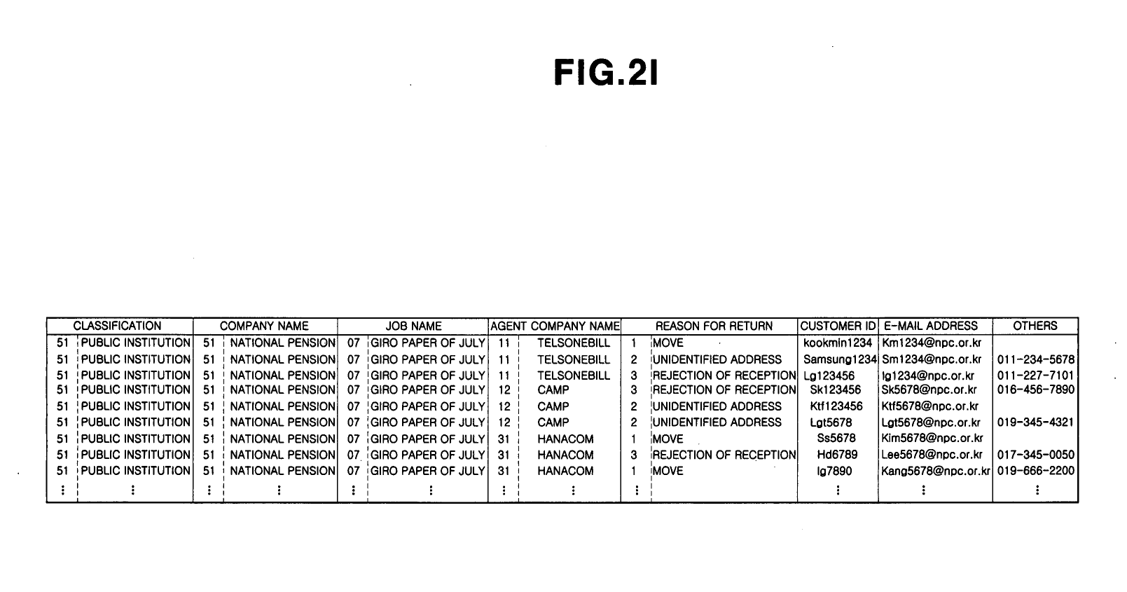

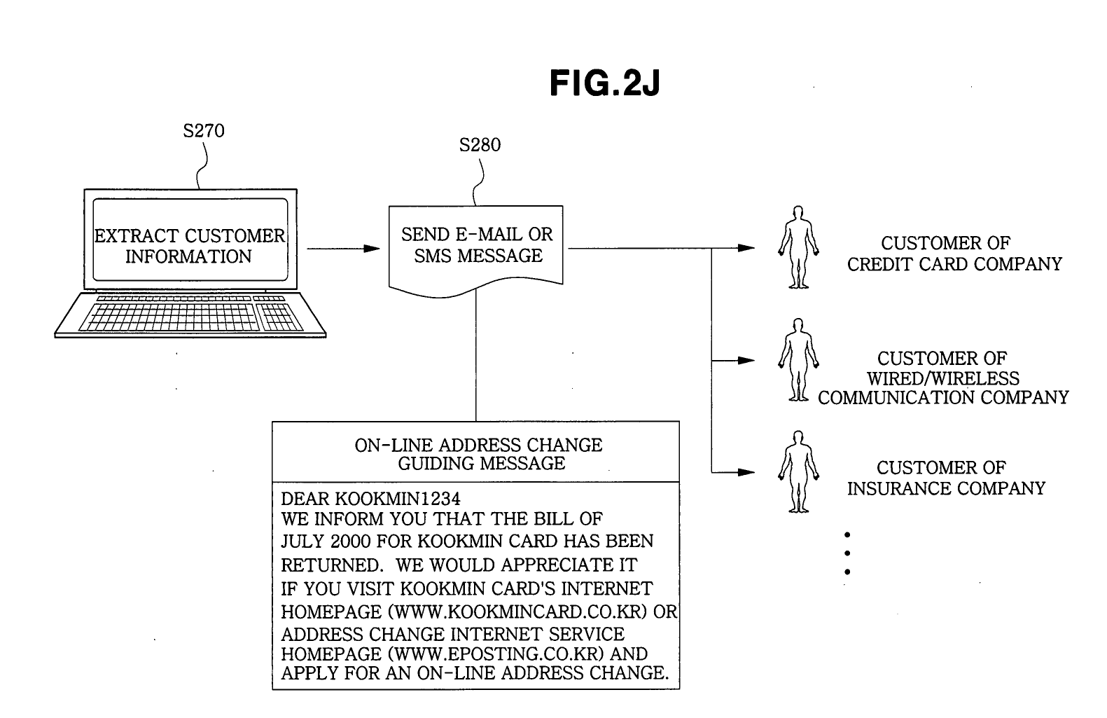

The mail agent company 120 receives the customer information and the mail content from the sender 110, prints a barcode (including a zip code number barcode and an information collection) and a recipient's address on an envelope, encloses a mail content (for example, a bill or a notification) in the envelope, and requests a mail center 130 to deliver the mailpiece. The mail agent company 120 is an agent company (for example, Telsonebill, Camp, or Hanyoung System) which is requested to forward a large amount of mail on behalf of the sender 110. The mail agent company includes a barcode printer which receives recipient's address information and mail information and prints a zip code number barcode and an information collection barcode at specified positions, respectively, on an envelope. The zip code number barcode is printed at a specified position in a specified format so that the mail center 130 automatically sorts mail by zone. The information collection barcode is printed at a specified position (for example, an upper portion or a left portion within a recipient address section) in a specified format (for example, a one-dimensional format or a two-dimensional format) so that returned mail information is obtained from the information collection barcode and made into a database. The returned mail information is reported to the sender 110, and the return of a mailpiece corresponding to the returned mail information is reported to the recipient 140 of the returned mailpiece. Examples of printing the zip code number barcode and the information collection barcode are shown in FIGS. 2A and 2B.

The mail center 130 obtains a zip code number by reading a zip code number barcode on a mailpiece received from the mail agent company 120, sorts the mailpiece to a zone corresponding to the zip code number, and delivers the mailpiece.

The returned mail agent company 150 collects returned mailpieces from the mail center 130, interprets an information collection barcode printed on each mailpiece, makes information on each returned mailpiece, i.e., returned mail information, into a database according to the sender 110 of the returned mailpiece, reports the returned mail information to the corresponding sender 110, and reports the return of the mailpiece to the recipient 140 of the returned mailpiece through a communication network. The returned mail agent company 150 collects returned mailpieces from the mail center 130 in a lump and may be a designated post office or a unified agent company (for example, e-posting). The returned mail agent company 150 uses a communication network to report the return of a mailpiece to the recipient 140. The communication network may be Internet when the return of a mailpiece is reported by e-mail or a mobile communication network when the return of a mailpiece is reported using a short message service (SMS). Upon receiving the report on the return of a mailpiece from the returned mail agent company 150, the recipient 140 accesses a site of the sender 110 or an address change Internet service homepage (for example, an e-posting (www.eposting.co.kr)) and revises his/her personal information so that disadvantage due to the return of a mailpiece can be minimized.

FIG. 2 is a diagram showing a procedure in which a returned mail agent company processes returned mail according to the present invention. The returned mail agent company collects returned mailpieces from a mail center (S210). The returned mailpieces are mailpieces, which senders such as a credit card company, a wired/wireless communication company, an insurance company, a telephone office, a national health insurance corporation, and a national pension corporation have request a mail agent company to forward on behalf of them and which are returned to the senders. The returned mail agent company sorts the returned mailpieces by reason for return (for example, a move, an unidentified address, or rejection of reception), records a reason for return of each returned mailpiece, transports the sorted returned mailpieces using a conveyor system, performs high and low speed scanning of each returned mailpiece to read data from a barcode on each returned mailpiece, and constructs a database of returned mail information including a mail information and a reason for return of each returned mailpiece using the read data (S220). Next, the returned mail agent company reports reasons for return to each corresponding sender based on the database including the returned mail information and the reason for return (S230). In addition, the returned mail agent company reads customer information contained in the returned mail information and reports the return of a mailpiece to a corresponding customer who is supposed to receive the mailpiece (S240). Processing of a returned mailpiece will be described in detail with reference to the attached relevant drawings later.

FIG. 2A is a diagram showing a barcoded envelope, which includes a one-dimensional barcode, according to an embodiment the present invention. FIG. 2B is a diagram showing a barcoded envelope, which includes a two-dimensional barcode, according to another embodiment of the present invention.

Referring to FIG. 2A, an information collection barcode is a one-dimensional barcode. In this situation, a zip code number barcode 210 is printed on the envelop to be positioned on a bottom line within a recipient address section, and a one-dimensional information collection barcode 220 is printed at a predetermined position, for example, on an upper line within the recipient address section on the envelope. A technique relating to a one-dimensional barcode has already been known to those skilled in the art, and thus a detailed description thereof will be omitted.

Referring to FIG. 2B, an information collection barcode is a two-dimensional barcode. In this situation, the zip code number barcode 210 is printed on the envelop to be positioned on the bottom line within the recipient address section, and a two-dimensional information collection barcode 230 is printed at a predetermined position, for example, at a left portion within the recipient address section on the envelope. The two-dimensional information collection barcode 230 includes a position detector for indicating a barcode area; an encoding region including a header including information on general factors of the barcode, such as a barcode type, a barcode version, and an error correction rate, real data, and codeword information for error correction; a separator composed of a set of white modules having a predetermined size (for example, one module) to separate the position detector from the encoding region; and a quiet zone composed of a set of white module having a predetermined size (for example, 16 modules) to separate the barcode area from other portions.

FIG. 2C is a diagram showing a structure of an information collection barcode according to the present invention. FIG. 2D is a diagram showing a structure of a database related to information collection barcodes according to the present invention.

As shown in FIG. 2C, the information collection barcodes 220 and 230 shown in FIGS. 2A and 2B include a classification field 241 for distinguishing a sender requesting forwarding of a large amount of mail by category (for example, a credit card company, an insurance company, or a mobile communication company); a company name field 242 indicating the sender; a job name field 243 for distinguishing mail content by type of job (for example, a bill, a termination notification, or a notice); an agent company name field 244 indicating an agent company (for example, Telsonebill, Camp, Hanyoung System, or Hanacom) which is requested to forward the large amount of mail; a customer ID field 245 indicating an ID of a customer who is managed by the sender and is supposed to receive the relevant mailpiece; an e-mail address field 246 indicating the customer's e-mail address; and an “others” field 247 containing other information (for example, customer's telephone number. Accordingly, based on information obtained by reading the information collection barcode 220 or 230 on a returned mailpiece, the returned mail agent company sorts the returned mailpiece by reason for return and reports the return of the mailpiece to a recipient of the returned mailpiece by e-mail so that the recipient can quickly revise his/her customer information. Fields constituting the database related to information collection barcodes can be freely changed according to designer's selection.

As shown in FIG. 2D, information on mailpieces is made into a database and represented as a barcode. For example, when a bill of July for a Kookmin card is forwarded to a customer named kookmin1234 via an agent company Telsonebill, an information collection barcode is formed by allocating a barcode indicating a value of “11” to the classification field 241, allocating a barcode indicating a value of “11” to the company name field 242, allocating a barcode indicating a value of “07” to the job name field 243, allocating a barcode indicating a value of “11” to the agent company name field 244, allocating a barcode indicating “kookmin1234” to the customer ID field 245, allocating a barcode indicating “Km1234@kookmin.co.kr” to the e-mail address field 246, and allocating a barcode indicating “011-123-3333” to the others field 247. Each of the customer ID field 245, the e-mail address field 246, and the others field 247 is allocated a barcode based on customer information transmitted from a sender. Accordingly, information necessary for processing a returned mailpiece can be easily obtained by interpreting the information collection barcode on the returned mailpiece.

FIG. 2E is a diagram showing a procedure of scanning a barcode according to the present invention. The returned mail agent company 150 shown in FIG. 1 sorts returned mailpieces by reason for return, stacks the returned mailpieces at a predetermined position, for example, in a mail container (not shown), and transports them along a predetermined path using a transport means, for example, a fast conveyor system 250. When the returned mailpieces reach a predetermined position, information is obtained by reading an information collection barcode on each returned mailpiece using a fast barcode scanner 260 and then transmitted to a particular server, i.e., mail processing server 270. Thereafter, returned mailpieces whose information collection barcodes are normally read and returned mailpieces whose information collection barcodes are not normally read are separately output to predetermined positions, for example, a normal output box (not shown) and an error output box (not shown), respectively. The information collection barcodes which have not been normally read are read again using a barcode hand scanner 280 to obtain barcode data, and the barcode data is transmitted to the particular server, i.e., the mail processing server 270. When there are a lot of mailpieces whose information collection barcodes are not normally read, the mailpieces can be stacked again in the mail container to be scanned fast. The mail processing server 270 can detect the total number of returned mailpieces, the number of returned mailpieces whose information collection barcodes are normally read, and the number of returned mailpieces whose information collection barcodes are not normally read based on the barcode data transmitted from the fast barcode scanner 260 and the barcode hand scanner 280.

FIG. 2F is a diagram showing a procedure of reporting a reason for return according to the present invention. A particular server, i.e., a mail processing server, stores returned mail information obtained by scanning an information collection barcode on a returned mailpiece (S250), produces a database including the returned mail information together with a reason for return of a corresponding mailpiece (S260), and transmits the reason for return to a corresponding sender (for example, a credit card company, a wired/wireless communication company, or an insurance company) through a communication network, for example, the Internet. The database includes a company name field 291 indicating a sender requesting the forwarding of a large amount of mail, a job name field 292 for distinguishing mail content by type of job (for example, a bill, a termination notification, or a notice), an agent company name field 293 indicating an agent company (for example, Telsonebill, Camp, Hanyoung System, or Hanacom) which is requested to forward the large amount of mail, a reason-for-return field 294 indicating a reason for return of a mailpiece, and an “others” field 295 containing other information (for example, a date on which relevant information is stored in the database). The reason-for-return field 294 includes a move field 294a, an unidentified address field 294b, a rejection-of-reception field 294c, and a total field 194d to indicate detailed reasons for return and a total of mailpieces corresponding to each reason for return. The fields of the database on the returned mail information sorted by reason for return can be freely changed according to a designer's selection. An example of the database on the returned mail information sorted by reason for return is shown in FIG. 2G. An example of statistical information contained in a report which informs a particular sender of returned mail information is shown in FIG. 2H. An example of particulars of a report which informs a particular sender of returned mail information is shown in FIG. 2I. A returned mail agent company can analyze the number of returned mailpieces of each sender, the number of returned mailpieces corresponding to each reason for return, the number of returned mailpieces per month, the number of returned mailpieces of each agent company, a reason for return of a mailpiece which is forwarded to each customer by a particular sender, etc. based on returned mail information and a corresponding reason for return.

FIG. 2J illustrates a service procedure of guiding customers to change their addresses according to the present invention. A particular server, i.e., a mail processing server extracts customer information (for example, a customer ID, a customer's e-mail address, and a customer's mobile phone number) from returned mail information stored in a database (S270) and reports the return of mailpieces to corresponding customers, i.e., recipients of respective returned mailpieces, by sending e-mail through the Internet or an SMS message through a mobile communication network (S280). For example, when the return of a mailpiece is reported to a corresponding recipient through the Internet, an on-line address change guiding message (e.g., “Dear Kookmin1234. We inform you that the bill of July 2000 for Kookmin card has been returned. We would appreciate it if you visit an internet homepage “www.kookmincard.co.kr” or “www.eposting.co.kr” and apply for an on-line address change”) can be composed and sent to the recipient to guide the recipient to quickly change his/her address. When the return of a mailpiece is reported to a corresponding recipient through a mobile communication network, an on-line address change guiding message (e.g., “Bill of July for Kookmin card is returned. Please change your address on kookmin card homepage or e-posting homepage”) can be sent using an SMS. Then, the recipient receiving the on-line address change guiding message can quickly change his/her address so that he/she can normally receive mailpieces forwarded by a corresponding sender.

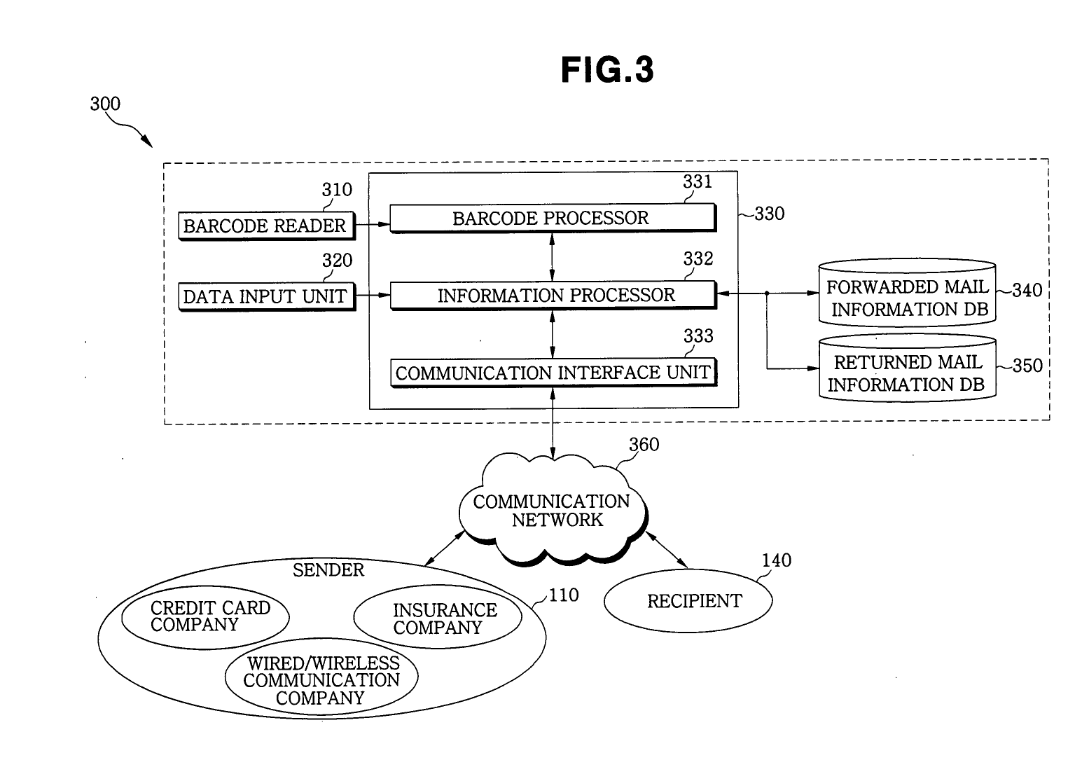

FIG. 3 is a diagram showing a structure to which a system 300 for processing returned postal mail according to an embodiment of the present invention is applied. The system 300 includes a barcode reader 310, a data input unit 320, a mail processing server 330, a forwarded mail information database (DB) 340, and a returned mail information DB 350. The mail processing server 330 includes a barcode processor 331, an information processor 332, and a communication interface unit 333.

The barcode reader 310 reads a particular type of barcode, i.e., an information collection barcode, on a returned mailpiece received from a mail center. The barcode reader 310 reads barcode information in the same manner as barcodes on a large amount of normal mailpieces are read. In other words, returned mailpieces stacked in a mail container is transported along a predetermined path using a transport means, an information collection barcode on each returned mailpiece is read using a fast barcode scanner, and data read from the information collection barcode is transmitted on a predetermined route. Returned mailpieces whose barcodes are not normally read by the fast barcode scanner are sorted out, and a barcode on each the sorted returned mailpieces can be read again using a barcode hand scanner.

The data input unit 320 generates and outputs a key signal ordering a particular operation to be executed or receives and transmits particular data, for example, mail information or a reason for return. The data input unit 320 is used to input information regarding a mailpiece when the mailpiece is received off-line or to input various types of data necessary for operating the system 300.

The mail processing server 330 is connected to the barcode reader 310, the data input unit 320, and a communication network 360. The mail processing server 330 transmits data to and receives data from the communication network 360, arithmetically processes mail information read by the barcode reader 310 and various types of data received from the data input unit 320, makes the arithmetically processed data into a DB, manages the DB, and controls elements of the system to perform predetermined operations.

The mail processing server 330 includes a barcode processor 331, an information processor 332, and a communication interface unit 333. The barcode processor 331 is connected to the barcode reader 310 and sequentially transmits data read by the barcode reader 310 on a predetermined route, i.e., to the information processor 332. The information processor 332 is connected to the data input unit 320 and the barcode processor 331, arithmetically processes various types of data received from the data input unit 320 and mail information received from the barcode processor 331, and makes the arithmetically processed information into a DB. In addition, the information processor 332 manages particular data, for example, forwarded mail information, returned mail information, or a guiding message, to be transmitted to or received from the communication network 360. The communication interface unit 333 is connected to the communication network 360 and the information processor 332, and controls an operation timing and a format of the particular data so that the particular data can be transmitted and received between the information processor 332 and the communication network 360 according to a predetermined communication protocol.

The forwarded mail information DB 340 is connected to the information processor 332, constructs a DB of forwarded mail information received from the information processor 332, extracts data in response to a request from the information processor 332, and transmits the data to the information processor 332. The forwarded mail information includes a recipient's address and various types of mail information (e.g., a classification, a company name, a job name, an agent company, a customer ID, and a customer's e-mail). A structure of a DB of an information collection barcode containing forwarded mail information according to the present invention is shown in FIG. 2D.

The returned mail information DB 350 is connected to the information processor 332, constructs a DB of returned mail information received from the information processor 332, extracts data in response to a request from the information processor 332, and transmits the data to the information processor 332. A structure of the DB of the returned mail information is shown in FIG. 2G.

Hereinafter, an operational relationship between a system and a method for processing returned postal mail using barcode application technology according to the present invention will be described in detail with reference to the attached drawings.

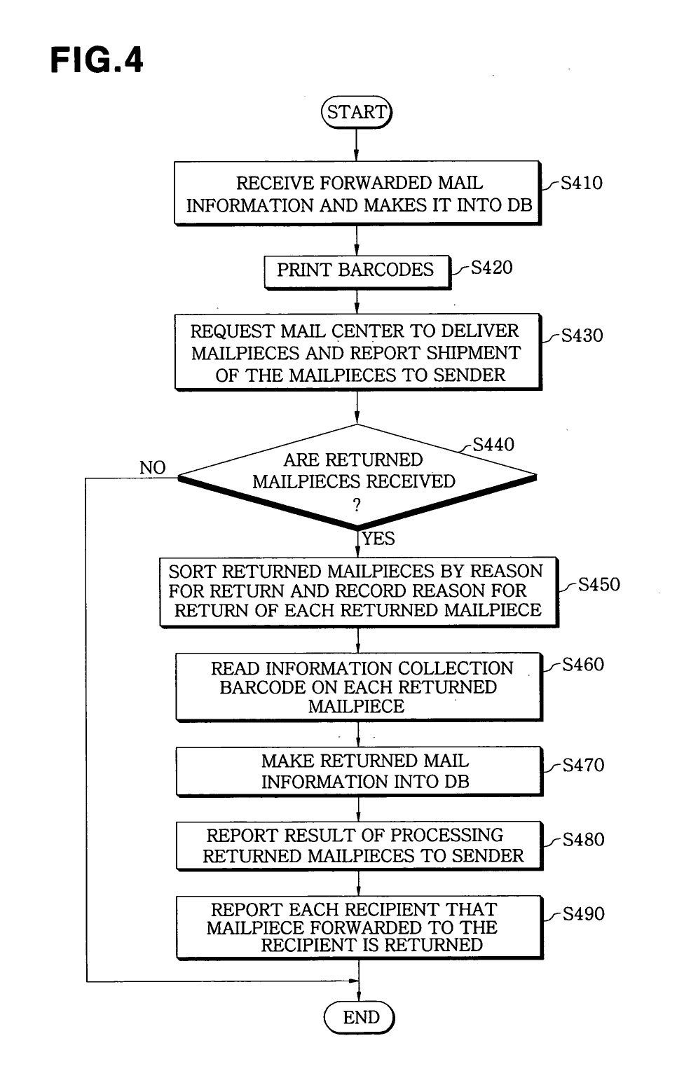

FIG. 4 is a flowchart of an operation of a system for processing returned postal mail according to an embodiment of the present invention. A mail agent company receives forwarded mail information from a sender via an on-line (i.e., a communication network) or an off-line and makes the forwarded mail information into a DB (S410). The forwarded mail information includes a recipient's address and various types of mail information (e.g., a classification, a company name, a job name, an agent company, a customer ID, and a customer's e-mail). It is preferable to separately manage a sender's address, a recipient's address, and mail information with respect to a forwarded mailpiece in order to write a sender's address on a sender section and a recipient address on a recipient section on an envelope and print a barcode containing mail information at a predetermined position on the envelope. Part of the forwarded mail information is expressed as a barcode and is made into a DB as shown in FIG. 2D.

Next, the mail agent company extracts a recipient's address and corresponding mail information from the DB and prints a barcode containing the corresponding mail information at a predetermined position on an envelope (S420). The barcode is printed using a barcode printer installed in the mail agent company. As shown in FIGS. 2A and 2B, the barcode printed on the envelope includes a zip code number barcode and an information collection barcode. A barcode processor of the system generates a zip code number based on the recipient's address and orders the zip code number barcode to be printed. In addition, the barcode processor orders the information collection barcode to be printed in a predetermined format based on the mail information. Here, the sender section and the recipient section on an envelope are defined according to conventional technology.

After printing a barcode on an envelope of each mailpiece, the mail agent company encloses a content (for example, a bill or a notice) in a corresponding envelope. The mail agent company requests a mail center to deliver a large number of mailpieces and then reports the shipment of the mailpieces to the sender (S430).

Thereafter, a returned mail agent company determines whether any returned mailpieces are received from the mail center (S440). If any returned mailpieces are received, the returned mail agent company sorts the returned mailpieces by reason for return (for example, a move, an unidentified address, or a rejection of reception) and records the reason for return of each returned mailpiece (S450). Next, the returned mail agent company reads an information collection barcode, which has been printed on each returned mailpiece during mail forwarding, using a barcode reader (S460) and makes returned mail information into a DB (S470). The returned mail information is transmitted to an information processor through a barcode processor. The information processor arithmetically processes the returned mail information and instructs a returned mail information DB to make the arithmetically processed returned mail information into a DB. A DB of the returned mail information is shown in FIG. 2G. A mail processing server reports the result of processing the returned mailpieces to the sender through a communication network (S480). The mail processing server also extracts a customer ID and an e-mail address of each recipient from the returned mail information and reports the recipient that a mailpiece having been forwarded to the recipient is returned (S490). For example, when the return of the mailpiece is reported to the recipient through the Internet, an on-line address change guiding message (e.g., “Dear Kookmin1234. We inform you that the bill of July 2000 for Kookmin card has been returned. We would appreciate it if you visit an internet homepage “www.kookmincard.co.kr” or “www.eposting.co.kr” and apply for an on-line address change”) can be composed and sent to the recipient to guide the recipient to quickly change his/her address. In another case, when the returned mail information includes the recipient's mobile phone number, a short message (e.g., “Bill of July for Kookmin card is returned. Please change your address on kookmin card homepage or e-posting homepage”) can be sent to the recipient through a mobile communication network.

As described above, according to the present invention, returned mailpieces are processed using barcode application technology so that a ratio of the number of returned mailpieces to the number of forwarded mailpieces can be remarkably reduced. As a result, the present invention provides advantage of cost reduction for a sender and prevents a recipient from having poor credit or delaying payment due to the return of mailpieces forwarded to the recipient.

In addition, in the present invention, an information collection barcode containing particular information regarding a mailpiece (for example, a sender classification, a sender company name, an agent company name, a customer ID, a customer's e-mail address, and a customer's mobile phone number) is printed on a predetermined position on an envelope together with a barcode for distinguishing zones, i.e., a zip code number barcode, when the mailpiece is forwarded. Accordingly, information on the recipient can be read by fast scanning the information collection barcode on an envelope of a returned mailpiece, and the returned mail can be quickly handled using the read information.

According to the present invention, a sender receives information regarding a returned mailpiece from a returned mail agent company via an on-line so that forwarding of a mailpiece to a customer can be appropriately handled according to a reason for return of a mailpiece to the customer. As a result, occurrence of returned mail can be minimized, and time and labor required to handle returned mail can be remarkably reduced.

Moreover, in the present invention, the returned mail agent company or the sender reports a recipient that a mailpiece which has been forwarded to a recipient is returned via an on-line in real time using an Internet e-mail service or an SMS so that the recipient can quickly revise his/her personal information. As a result, disadvantage such as poor credit or overdue interest caused by return of a mailpiece can be prevented.

Although a few embodiments of the present invention have been shown and described, it will be appreciated by those skilled in the art that changes may be made in these elements without departing from the principles and spirit of the invention, the scope of which is defined in the appended claims and their equivalents.

1. A system for processing returned postal mail using barcode application technology, the system receiving addresses of respective recipients, to whom a large number of mailpieces are to be forwarded in response to a sender's request, and mail information; printing a zip code number barcode and an information collection barcode on predetermined positions, respectively, on an envelope using a barcode printer included in a mail agent company; requesting a mail center to deliver a large number of mailpieces; making returned mail information regarding each returned mailpiece received from the mail center into a database; reports the returned mail information to the sender through a communication network; and reporting a recipient that a mailpiece having been forwarded to the recipient is returned through the communication network, the system comprising:
a barcode reader which reads a particular barcode on each returned mailpiece received from the mail center;
a data input unit which generates and outputs a key signal ordering a particular operation to be executed or receives and transmits particular data;
a mail processing server connected to the communication network, the barcode printer, the barcode reader, and the data input unit, the mail processing server transmitting data to and receiving data from the communication network, arithmetically processing the mail information obtained by the barcode reader and various types of data received from the data input unit, manages the mail information and the data to be made into a database, and controlling elements of the system to perform predetermined operations;
a forwarded mail information database connected to the mail processing server, the forwarded mail information database making forwarded mail information received from the mail processing server into a database, and extracting and outputting data in response to a request from the mail processing server; and
a returned mail information database connected to the mail processing server, the returned mail information database making returned mail information received from the mail processing server into a database, and extracting and outputting data in response to a request from the mail processing server.

2. The system of claim 1, wherein the mail processing server comprises:
a barcode processor connected to the barcode reader, the barcode processor sequentially transmitting the mail information obtained by the barcode reader along a predetermined path;
an information processor connected to the data input unit and the barcode processor, the information processor arithmetically processing the mail information received from the barcode processor and the various types of data received from the data input unit, managing the mail information and the data to be made into a database, and manages particular data to be transmitted to or received from the communication network; and
a communication interface unit connected to the communication network and the information processor, the communication interface unit controlling an operation timing and a format of the particular data so that the particular data can be transmitted and received between the information processor and the communication network according to a predetermined communication protocol.

3. The system of claim 1, wherein the information collection barcode comprises the mail information, is a one-dimensional barcode or a two-dimensional barcode, and is printed on a predetermined position on the envelope.

4. The system of claim 3, wherein the information collection barcode comprises a classification field for distinguishing a sender requesting forwarding of a large amount of mail by category, a company name field indicating the sender, a job name field for distinguishing mail content by type of job, an agent company name field indicating an agent company requested to forward the large amount of mail, a customer ID field indicating an ID of a customer who is managed by the sender and is supposed to receive the relevant mailpiece, an e-mail address field indicating the customer's e-mail address, and an “others” field containing other information.

5. The system of claim 1, wherein the information collection barcode comprises a classification field for distinguishing a sender requesting forwarding of a large amount of mail by category, a company name field indicating the sender, a job name field for distinguishing mail content by type of job, an agent company name field indicating an agent company requested to forward the large amount of mail, a customer ID field indicating an ID of a customer who is managed by the sender and is supposed to receive the relevant mailpiece, an e-mail address field indicating the customer's e-mail address, and an “others” field containing other information.

6. The system of claim 1, wherein the forwarded mail information comprising a recipient's address and the mail information, and the returned mail information comprises a reason for return of each mailpiece and the mail information.

7. The system of claim 1, wherein the mail processing server reports a result of processing the returned mailpieces to the sender through the communication network, extracts recipient information from the returned mail information, and reports the recipient that a mailpiece having been forwarded to the recipient is returned through the communication network.

8. A method of processing returned postal mail using barcode application technology, the method in which addresses of respective recipients, to whom a large number of mailpieces are to be forwarded in response to a sender's request, and mail information are received; a zip code number barcode and an information collection barcode are printed on predetermined positions, respectively, on an envelope using a barcode printer included in a mail agent company; a mail center is requested to deliver a large number of mailpieces; returned mail information regarding each returned mailpiece received from the mail center is made into a database; the returned mail information is reported to the sender through a communication network; and a recipient is reported through the communication network that a mailpiece having been forwarded to the recipient is returned, the method comprising:
receiving forwarded mail information from the sender and making the forwarded mail information into a database;
extracting a recipient's address and corresponding mail information from the forwarded mail information, printing a zip code number barcode and an information collection barcode on predetermined positions, respectively, on an envelope, and reporting mail shipment to the sender;
receiving returned mailpieces, sorting the returned mailpieces by reason for return, and recording a reason for return of each returned mailpiece;
reading the information collection barcode printed on each returned mailpiece and making returned mail information into a database; and
reporting a result of processing the returned mailpieces to the sender through the communication network, extracting recipient information from the returned mail information, and reporting a corresponding recipient through the communication network that a mailpiece having been forwarded to the recipient is returned.

9. The method of claim 8, the information collection barcode comprises the mail information, is a one-dimensional barcode or a two-dimensional barcode, and is printed on a predetermined position on the envelope.

10. The method of claim 9, wherein the information collection barcode comprises a classification field for distinguishing a sender requesting forwarding of a large amount of mail by category, a company name field indicating the sender, a job name field for distinguishing mail content by type of job, an agent company name field indicating an agent company requested to forward the large amount of mail, a customer ID field indicating an ID of a customer who is managed by the sender and is supposed to receive the relevant mailpiece, an e-mail address field indicating the customer's e-mail address, and an “others” field containing other information.

11. The method of claim 8, wherein the information collection barcode comprises a classification field for distinguishing a sender requesting forwarding of a large amount of mail by category, a company name field indicating the sender, a job name field for distinguishing mail content by type of job, an agent company name field indicating an agent company requested to forward the large amount of mail, a customer ID field indicating an ID of a customer who is managed by the sender and is supposed to receive the relevant mailpiece, an e-mail address field indicating the customer's e-mail address, and an “others” field containing other information.

12. The method of claim 8, wherein the forwarded mail information comprising a recipient's address and the mail information, and the returned mail information comprises a reason for return of each mailpiece and the mail information.
